(19) United States
(12) Patent Application Publication
(10) Pub. No.: US 2026/0313638 A1
(43) Pub. Date: Oct. 8, 2026

(54) SCHEDULING REQUEST METHOD AND COMMUNICATION APPARATUS

(71) Applicant: HUAWEI TECHNOLOGIES CO., LTD., Shenzhen (CN)

(72) Inventors: Lei Wang, Shenzhen (CN); Jianglei Ma, Ottawa (CA); Xiaoyan Bi, Shanghai (CN); Zonghao Huang, Kista (SE)

(21) Appl. No.: 19/531,763

(22) Filed: Feb. 6, 2026

Related U.S. Application Data
(63) Continuation of application No. PCT/CN2023/111618, filed on Aug. 8, 2023.

(51) Int. Cl. H04W 72/1263; H04L 5/00

(52) U.S. Cl. CPC H04W 72/1263; H04L 5/0044

(57) ABSTRACT

This application provides a scheduling request method and a communication apparatus, relating to the field of communication technologies. The method includes: A network device sends first configuration information, where the first configuration information includes a group identifier of a first terminal device group and resource indication information, and the resource indication information indicates a resource set allocated to the first terminal device group for transmission of a scheduling request signal; and the network device receives, on a part or all of the resource set, a scheduling request SR signal sent by one or more terminal devices in the first terminal device group.

### CROSS-REFERENCE TO RELATED APPLICATIONS

This is a continuation of International Patent Application No. PCT/CN2023/111618, filed on Aug. 8, 2023, the disclosure of which is hereby incorporated by reference in its entirety.

### TECHNICAL FIELD

This application relates to the field of communication technologies, and in particular, to a scheduling request method and a communication apparatus.

### BACKGROUND

A scheduling request (SR) signal is a signal used by a terminal device to request uplink data transmission. However, with the development of the era, there are more terminal devices. When there are a large quantity of terminals in a connected state in a cell, overheads of SR resources pre-configured for each terminal device become excessive, and this has become one of performance bottlenecks of a live network. The SR resource is a resource for transmission of SR signals. Currently, how to reduce the overheads of the SR resource is a technical problem to be urgently resolved.

### SUMMARY

This application provides a scheduling request method and a communication apparatus. The method described in this application helps reduce overheads of an SR resource.

According to a first aspect, this application provides a scheduling request method. The method includes: sending first configuration information, where the first configuration information includes a group identifier of a first terminal device group and resource indication information, and the resource indication information indicates a resource set allocated to the first terminal device group for transmission of a scheduling request signal; and receiving, on a part or all of the resource set, a scheduling request signal sent by one or more terminal devices in the first terminal device group.

Based on the method described in the first aspect, a plurality of terminal devices can share an SR resource, to reduce overheads of the SR resource.

In a possible implementation, after the receiving, on the part or all of the resource set, the scheduling request signal sent by the one or more terminal devices in the first terminal device group, the method further includes: sending, on a first resource, downlink control information DCI corresponding to the first terminal device group, where the DCI is used to schedule the one or more terminal devices to perform uplink transmission, and the first resource is determined based on a response window parameter and the part or all of the resource set that carries the scheduling request signal; and receiving uplink data from the one or more terminal devices. Based on this implementation, each terminal device in the first terminal device group can receive, at a specific time-frequency resource location, DCI corresponding to the terminal device.

In a possible implementation, the first configuration information further includes a resource offset, and the resource offset is used to determine a resource that carries the uplink data of the terminal device. Based on this implementation, each terminal device in the first terminal device group has a different resource offset. When a same time-frequency resource is scheduled for a plurality of terminal devices in the group, different resource offsets are superimposed, so that each terminal device can use a different resource for uplink transmission, to avoid a resource conflict. In addition, a network device may further determine, based on resources carried by different data, a terminal device that sends the data.

In a possible implementation, generation of the DCI is related to the group identifier of the first terminal device group, and the DCI includes scheduling information for uplink transmission and a parity bit corresponding to the DCI. Based on this implementation, a case in which a device other than the first terminal device group reads the DCI may be avoided.

In a possible implementation, the first configuration information further includes a pilot scrambling code identifier, and a pilot port or a pilot sequence of the uplink data of the terminal device is related to the pilot scrambling code identifier. Based on this implementation, different terminal devices in the first terminal device group have different pilot scrambling code identifiers, so that a network device can determine, by blindly detecting a pilot signal of the uplink data, a terminal device that sends the data.

In a possible implementation, a scrambling sequence of the uplink data of the terminal device is related to a specific identifier of the terminal device. Based on this implementation, different terminal devices in the first terminal device group have different specific identifiers, so that a network device can determine, by blindly detecting the uplink data, a terminal device that sends the data.

In a possible implementation, before the sending the first configuration information, the method further includes: grouping a plurality of terminal devices based on sensing information, where a grouping result includes the first terminal device group, and the sensing information is used to position the terminal device, and/or used to determine channel state information of the terminal device. A network device may group, by using the sensing information, terminal devices with close locations or beams into one group, so that the terminal devices with close locations or beams can share a same resource set. This helps implement the method described in this application. For example, terminals in a same beam range may be grouped into one group, to ensure that the group of terminal devices have a same large-scale channel characteristic. In addition, the network device may further estimate, with assistance of an echo signal, power strength of the SR signal sent by one terminal device, to estimate, based on power strength of the received SR signal, a quantity of terminal devices that send the SR signal, and infer a quantity of terminal devices that subsequently send the uplink data. This helps reduce a delay of detecting a channel corresponding to the uplink data.

According to a second aspect, this application provides a scheduling request method. The method includes: receiving first configuration information from a network device, where the first configuration information includes a group identifier of a first terminal device group and resource indication information, and the resource indication information indicates a resource set allocated to the first terminal device group for transmission of a scheduling request signal; and sending a scheduling request signal to the network device on a part or all of the resource set. For the second aspect and beneficial effects corresponding to the second aspect, refer to the descriptions corresponding to the foregoing first aspect. Details are not described herein again.

In a possible implementation, after the sending the scheduling request signal to the network device on the part or all of the resource set, the method further includes: receiving downlink control information DCI from the network device on a first resource, where the DCI is used to schedule a terminal device to perform uplink transmission, and the first resource is determined based on a response window parameter and the part or all of the resource set that carries the scheduling request signal; and sending uplink data to the network device.

In a possible implementation, the first configuration information further includes a resource offset, and the resource offset is used to determine a resource that carries the uplink data.

In a possible implementation, generation of the DCI is related to the group identifier of the first terminal device group, and the DCI includes scheduling information for uplink transmission and a corresponding parity bit.

In a possible implementation, the first configuration information further includes a pilot scrambling code identifier, and a pilot port or a pilot sequence of the uplink data is related to the pilot scrambling code identifier.

In a possible implementation, a scrambling sequence of the uplink data is related to a specific identifier of the terminal device.

In a possible implementation, the method further includes: sending an echo signal to the network device, where the echo signal is used to determine sensing information, and the sensing information is used to position the terminal device and/or used to determine channel state information of the terminal device.

According to a third aspect, this application provides a communication apparatus. The communication apparatus may alternatively be a chip system. The communication apparatus may perform the method according to the first aspect. A function of the communication apparatus may be implemented by hardware, or may be implemented by hardware executing corresponding software. The hardware or the software includes one or more units or modules corresponding to the foregoing function. The unit or the module may be software and/or hardware. For operations performed by the communication apparatus and beneficial effects thereof, refer to the method according to the first aspect and beneficial effects thereof. Repeated parts are not described again.

According to a fourth aspect, this application provides a communication apparatus. The communication apparatus may alternatively be a chip system. The communication apparatus may perform the method according to the second aspect. A function of the communication apparatus may be implemented by hardware, or may be implemented by hardware executing corresponding software. The hardware or the software includes one or more units or modules corresponding to the foregoing function. The unit or the module may be software and/or hardware. For operations performed by the communication apparatus and beneficial effects thereof, refer to the method according to the second aspect and beneficial effects thereof. Repeated parts are not described again.

According to a fifth aspect, this application provides a communication apparatus. The communication apparatus includes a processor; and when the processor invokes a computer program in a memory, the method according to the first aspect or the second aspect is performed.

In a possible implementation, the communication apparatus further includes the memory, and the memory and the processor are coupled to each other. Optionally, the memory and the processor are integrated together.

In a possible implementation, the communication apparatus further includes a transceiver, and the transceiver is configured to receive and send data and/or signaling.

According to a sixth aspect, this application provides a communication apparatus. The communication apparatus includes a processor and an interface circuit. The interface circuit is configured to receive a signal from another communication apparatus other than the communication apparatus and transmit the signal to the processor, or send a signal from the processor to another communication apparatus other than the communication apparatus. The processor performs the method according to the first aspect or the second aspect by using a logic circuit or by executing code instructions.

According to a seventh aspect, this application provides a computer-readable storage medium. The storage medium stores a computer program or instructions, and when the computer program or the instructions are executed by a communication apparatus, the method according to the first aspect or the second aspect is performed.

According to an eighth aspect, an embodiment of this application provides a computer program or a computer program product, including code or instructions. When the code or the instructions are run on a computer, the computer is caused to perform the method according to the first aspect or the second aspect.

According to a ninth aspect, an embodiment of this application provides a communication system. The system includes the communication apparatuses provided in the third aspect and the fourth aspect.

### BRIEF DESCRIPTION OF DRAWINGS

FIG. 1 is a diagram of a communication system according to an embodiment of this application;

FIG. 2 is a schematic flowchart of a scheduling request method according to an embodiment of this application;

FIG. 3 is a diagram of determining a first resource according to an embodiment of this application;

FIG. 4 is a diagram of determining a resource used for transmission of uplink data according to an embodiment of this application;

FIG. 5 is a diagram of a structure of a communication apparatus according to an embodiment of this application;

FIG. 6 is a diagram of a structure of another communication apparatus according to an embodiment of this application; and

FIG. 7 is a diagram of a structure of a chip according to an embodiment of this application.

### DESCRIPTION OF EMBODIMENTS

Terms "first", "second", and the like in this specification, the claims, and the accompanying drawings of this application are used to distinguish between different objects but do not indicate a particular sequence. In addition, terms "include" and "have" and any other variants thereof are intended to cover a non-exclusive inclusion. For example, a process, a method, a system, a product, or a device that includes a series of steps or units is not limited to listed steps or units, but optionally further includes an unlisted step or unit, or optionally further includes another inherent step or unit of the process, the method, the product, or the device.

An "embodiment" mentioned in this specification means that a particular feature, structure, or characteristic described with reference to the embodiment may be included in at least one embodiment of this application. The phrase shown in various locations of this specification does not necessarily refer to a same embodiment, and is not an independent or alternative embodiment exclusive from another embodiment. It is explicitly and implicitly understood by a person skilled in the art that embodiments described in this specification may be combined with another embodiment.

In this application, "at least one (item)" means one or more, "a plurality of" means two or more, "at least two (items)" means two, three, or more, and "and/or" is used to describe a correspondence relationship between associated objects, and indicates that three relationships may exist. For example, "A and/or B" may indicate that only A exists, only B exists, and both A and B exist, where A and B may be singular or plural. The character "/" generally indicates an "or" relationship between the associated objects. "At least one of the following items (pieces)" or a similar expression thereof means any combination of these items, including a single item (piece) or any combination of a plurality of items (pieces). For example, at least one item (piece) of a, b, or c may indicate a, b, c, "a and b", "a and c", "b and c", or "a, b, and c", where a, b, and c may be singular or plural.

The following describes a system architecture in embodiments of this application.

To facilitate understanding of technical solutions in embodiments of this application, the following briefly describes a system architecture of a method provided in embodiments of this application. It may be understood that the system architecture described in embodiments of this application is intended to describe the technical solutions in embodiments of this application more clearly, and does not constitute a limitation on the technical solutions provided in embodiments of this application.

The technical solutions in embodiments of this application may be applied to various communication systems such as a satellite communication system and a conventional mobile communication system. The satellite communication system may be integrated with the conventional mobile communication system (that is, a terrestrial communication system). The communication systems are, for example, a wireless local area network (wireless local area network, WLAN) communication system, a wireless fidelity (Wi-Fi) system, a long term evolution (LTE) system, an LTE frequency division duplex (FDD) system, an LTE time division duplex (TDD) system, a 5th generation (5G) system or a new radio (NR) system, and another future communication system like a 6th generation (6G) system. The communication systems further support a communication system that integrates a plurality of wireless technologies. For example, the communication systems may be further used in a system that integrates a terrestrial mobile communication network and a non-terrestrial network (NTN) such as an uncrewed aerial vehicle, a satellite communication system, or a high altitude platform station (HAPS) communication system.

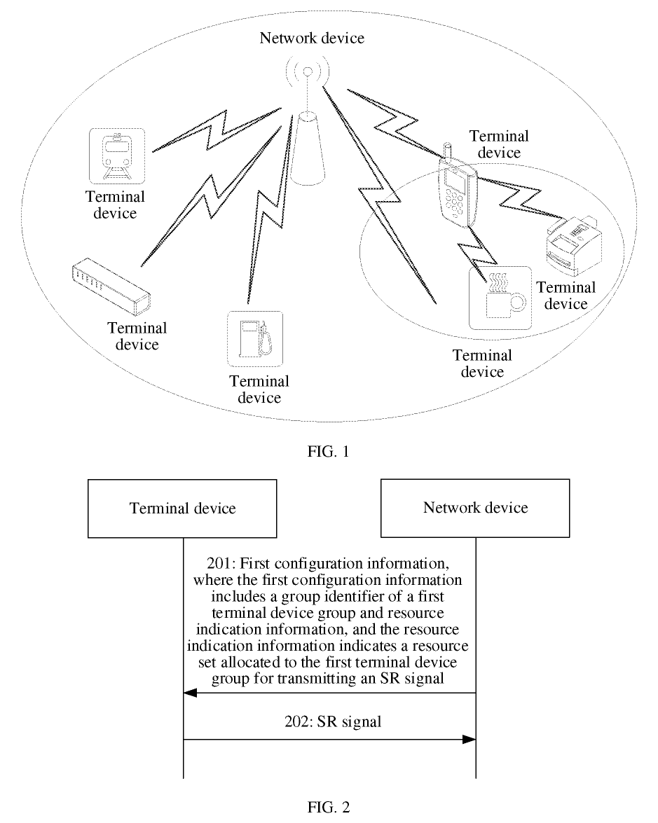

FIG. 1 shows an example of a communication system applicable to an embodiment of this application. The communication system includes at least one network device and at least one terminal device. In FIG. 1, one network device and a plurality of terminal devices are used as an example. The plurality of terminal devices may be a cellular phone, a smartphone, a portable computer, a handheld communication device, a handheld computing device, a satellite radio apparatus, a global positioning system, a personal digital assistant (PDA), and/or any other suitable device configured to perform communication in a wireless communication system. All of the terminal devices may be connected to the network device. All of the terminal devices can communicate with the network device. Certainly, a quantity of terminal devices and a quantity of network devices in FIG. 1 are merely an example, and there may alternatively be more or fewer terminal devices and more or fewer network devices.

The network device in this application has a wireless transceiver function, is configured to communicate with the terminal, and may be specifically a base station, an evolved NodeB (eNodeB), a transmission reception point (TRP), a next generation NodeB (gNB) in a 5G mobile communication system, a next generation base station in a 6th generation (6G) mobile communication system, an access network device or a module of the access network device in an open access network (ORAN) system, a base station in a future mobile communication system, an access node in a Wi-Fi system, or the like. The network device may alternatively be a module or a unit that can implement a part of functions of the base station. For example, the network device may be a central unit (CU), a distributed unit (DU), a CU-control plane (CP), a CU-user plane (UP), a radio unit (RU), or the like described below. In the ORAN system, the CU may also be referred to as an O-CU, the DU may also be referred to as an open (open, O)-DU, the CU-CP may also be referred to as an O-CU-CP, the CU-UP may also be referred to as an O-CU-UP, and the RU may also be referred to as an O-RU. For example, the base station in embodiments of this application may include various forms of base stations, for example, a macro base station, a micro base station (also referred to as a small cell), a relay station, an access point, a gNodeB (gNB), a transmitting and receiving point (TRP), a transmitting point (TP), and a mobile switching center. Alternatively, the base station may be a device or the like that undertakes a wireless access function in device-to-device (D2D) communication, vehicle-to-everything (V2X) communication, machine-to-machine (M2M) communication, or internet of things (Internet of Things) communication. In addition, in this application, unless otherwise specified, the "network device" may be the network device itself, or may be a component of the network device, for example, a chip system or a system-on-a-chip (SoC). The component may be installed in the network device.

The terminal device mentioned in embodiments of this application may be a device having a wireless transceiver function, and may be specifically user equipment (UE), an access terminal, a subscriber unit, a subscriber station, a mobile station, a remote station, a remote terminal, a mobile device, a user terminal, a wireless communication device, a user agent, or a user apparatus. The terminal device may alternatively be a satellite phone, a cellular phone, a smartphone, a wireless data card, a wireless modem, a machine-type communication device, a cordless phone, a session initiation protocol (SIP) phone, a wireless local loop (WLL) station, a PDA, a handheld device having a wireless communication function, a computing device or another processing device connected to the wireless modem, a vehicle-mounted device, a communication device mounted on a high-altitude aircraft, a wearable device, an uncrewed aerial vehicle, a robot, a terminal in device-to-device (D2D) communication, a terminal in vehicle-to-everything (V2X) communication, a virtual reality (VR) terminal device, an augmented reality (AR) terminal device, a wireless terminal in industrial control, a wireless terminal in self driving, a wireless terminal in remote medical, a wireless terminal in a smart grid, a wireless terminal in transportation safety, a wireless terminal in a smart city, a wireless terminal in a smart home, a terminal device in a future communication network, or the like. This is not limited in this application. In addition, in this application, unless otherwise specified, the "terminal device" may be the terminal device itself, or may be a component of the terminal device, for example, a chip system or an SoC. The component may be installed in the terminal device.

A scheduling request (SR) is used by the terminal device to request uplink data transmission. The network device periodically allocates, to the terminal device, a resource used for transmission of the SR. Correspondingly, the terminal device also periodically determines whether uplink data transmission needs to be performed. If uplink transmission needs to be performed, an SR signal is sent on a corresponding time-frequency resource. However, when a quantity of terminal devices in a connected state in a cell is large, and a quantity of time-frequency resources is limited, a period for each terminal device to obtain a resource used for transmission of an SR signal increases, and an uplink transmission delay of the terminal device may be further affected. Overheads of an SR resource pre-configured for each terminal device are excessively large, and this has become one of performance bottlenecks of a live network. Therefore, currently, how to reduce the overheads of the SR resource is a technical problem that needs to be urgently resolved.

To reduce overheads of an SR resource, an embodiment of this application provides a scheduling request method. As shown in FIG. 2, the scheduling request method includes step 201 and step 202. The method shown in FIG. 2 is performed by a terminal device and a network device. Alternatively, the method shown in FIG. 2 may be performed by a chip in the terminal device and a chip in the network device. In FIG. 2, the terminal device and the network device are used as an example for description. An execution entity of the scheduling request method is not limited in embodiments of this application. The terminal device and the network device may be the terminal device and the network device shown in FIG. 1.

201: The network device sends first configuration information. Correspondingly, the terminal device receives the first configuration information from the network device, where the first configuration information includes a group identifier of a first terminal device group and resource indication information, and the resource indication information indicates a resource set allocated to the first terminal device group for transmission of an SR signal.

In this embodiment of this application, the network device may send the first configuration information to the first terminal device group in a broadcast manner, a multicast manner, a unicast manner, or another manner. The first configuration information includes the group identifier of the first terminal device group. Optionally, the first configuration information may be carried in radio resource control (RRC) signaling. For example, the broadcast manner means that the network device simultaneously sends the first configuration information to all terminal devices in a network. All the terminal devices described herein are limited in a range, and the range may be referred to as a broadcast domain. All the terminal devices in the broadcast domain may belong to the first terminal device group. The multicast manner means that the network device simultaneously sends the first configuration information to a group of terminal devices, and the group of terminal devices may belong to the first terminal device group. The unicast manner means that the network device separately sends the first configuration information to each device in the first terminal device group. The first configuration information received by each terminal device in the first terminal device group includes a same group identifier of the first terminal device group and same resource indication information.

The first configuration information includes the group identifier of the first terminal device group and the resource indication information. The group identifier is used by a terminal device to determine a terminal device group to which the terminal device belongs, and is further used by the network device to distinguish between different terminal device groups. Optionally, the group identifier may be a scheduling request-radio network temporary identity (SR-RNTI). The resource indication information indicates the resource set allocated to the first terminal device group for transmission of the SR signal, and all terminal devices in the first terminal device group share the resource set. It may be understood that one terminal device group corresponds to one resource set, two terminal devices belonging to a same terminal device group share a same resource set, and two terminal devices belonging to different terminal device groups use different resource sets.

A terminal device needs to periodically obtain an SR resource. When the terminal device needs to perform uplink transmission, the terminal device sends an SR signal on an SR resource corresponding to a period, where the SR resource is a time-frequency resource used to send the SR signal. The resource set allocated to the first terminal device group for transmission of the SR signal is a periodic time-frequency resource set allocated to the first terminal device group for transmission of the SR signal, and the resource set includes a plurality of SR resources.

202: The terminal device sends an SR signal to the network device on a part or all of the resource set. Correspondingly, the network device receives, on the part or all of the resource set, an SR signal sent by one or more terminal devices in the first terminal device group.

In this embodiment of this application, the part or all of the resource set refers to a part or all of the resources in the resource set. When a terminal device needs to send data, the terminal device sends an SR signal on an SR resource corresponding to a current period. If the terminal device does not need to send data, the terminal device does not send the SR signal. After receiving the SR signal sent by the one or more terminal devices in the first terminal device group, the network device may determine that there is a terminal device in the first terminal device group needing to perform uplink transmission, and the network device allocates a resource to the first terminal device group. Based on this implementation, a plurality of terminal devices can share an SR resource, to reduce overheads of the SR resource.

In a possible implementation, the first configuration information further includes a response window parameter. After step 202 is performed, the method further includes: The network device sends, on a first resource, downlink control information (DCI) corresponding to the first terminal device group, where the DCI is used to schedule the one or more terminal devices to perform uplink transmission, and the first resource is determined based on the response window parameter and the part or all of the resource set that carries the SR signal; and after receiving the DCI, the terminal device sends uplink data to the network device, and correspondingly, the network device receives the uplink data from the one or more terminal devices.

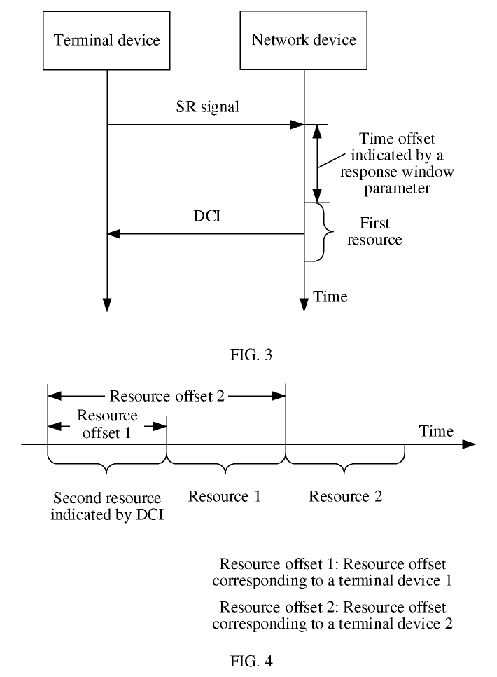

The response window parameter indicates the first resource with reference to the SR resource. The first resource is a resource used by the network device to send the DCI. The resource herein is a communication resource required by a base station to transmit the DCI, and includes one or more of resources such as a time domain resource and a frequency domain resource. The terminal device may determine the first resource based on a resource for sending the SR signal and the response window parameter, and listen to the DCI at a location of the first resource. Optionally, the response window parameter may be a time offset, and the location of the first resource is a location corresponding to the SR resource plus the time offset. For example, as shown in FIG. 3, after sending the SR signal, the terminal device determines the first resource based on the time offset indicated by the response window parameter and a location of the resource for sending the SR signal, and listens to, on the first resource, the DCI sent by the network device.

Each SR resource in the resource set corresponds to one first resource. For example, when a terminal device in the first terminal device group sends an SR signal on a first SR resource in the resource set, and correspondingly, the network device receives the SR signal on the first SR resource, both the terminal device and the network device may obtain, through calculation based on the first SR resource and the response window parameter, a first resource corresponding to the first SR resource. The terminal device listens to DCI on the first resource, and the network device sends the DCI on the first resource. A terminal device that sends an SR signal in the first terminal device group performs listening on a first resource, and a terminal device that does not send an SR signal in the first terminal device group does not perform listening.

The response window parameter, and the foregoing group identifier of the first terminal device group and the foregoing resource indication information may be sent simultaneously, or may be sent at different time. This is not limited in embodiments of this application.

In the first terminal device group, each terminal device corresponds to a same response window parameter. Based on this implementation, each terminal device in the first terminal device group can receive, at a specific time-frequency resource location, DCI corresponding to the terminal device.

Optionally, the first configuration information further includes a resource offset, and the resource offset is used to determine a resource that carries the uplink data of the terminal device. Each terminal device in the first terminal device group has a different resource offset. Specifically, in the foregoing implementation, the DCI sent by the network device includes scheduling information for uplink transmission, and the scheduling information for uplink transmission may be an uplink grant (UL Grant). The DCI indicates a second resource. The terminal device may determine, based on the resource offset and a location of the second resource, the resource used to carry the uplink data. For example, a location of the resource used for transmission of the uplink data is a resource location corresponding to the location of the second resource plus or minus the resource offset. Based on the method, different terminal devices in the first terminal device group have different resource offsets. When a same time-frequency resource is scheduled for a plurality of terminal devices in the group, different resource offsets are superimposed, so that each terminal device can use a different resource for uplink transmission, to avoid a resource conflict. In addition, the network device may further determine, based on resources carried by different uplink data, a corresponding terminal device that sends the uplink data.

For example, as shown in FIG. 4, it is assumed that in the first terminal device group, both a terminal device 1 and a terminal device 2 send an SR signal to the network device, and receive DCI from the network device, where the DCI indicates a second resource. Resource offsets obtained by the terminal device 1 and the terminal device 2 are different. The terminal device 1 corresponds to a resource offset 1, and the terminal device 2 corresponds to a resource offset 2. The terminal device 1 determines a resource 1 based on the resource offset 1 and a location of the second resource, where the resource 1 is a resource used by the terminal device 1 to transmit uplink data. The terminal device 2 determines a resource 2 based on the resource offset 2 and the location of the second resource, where the resource 2 is a resource used by the terminal device 2 to transmit uplink data. The resource 1 and the resource 2 do not overlap each other. Therefore, when the terminal device 1 and the terminal device 2 perform uplink data transmission, no conflict occurs. The resource offsets in the example in FIG. 4 represent offsets in time domain, and the resource offsets may alternatively be offsets in frequency domain, or offsets respectively corresponding to a time domain and a frequency domain.

The resource offset, and the foregoing group identifier of the first terminal device group and the foregoing resource indication information may be sent simultaneously, or may be sent at different time. When the network device sends the first configuration information in the broadcast or multicast manner, the first configuration information may include resource offsets corresponding to all the terminal devices in the first terminal device group. After receiving the first configuration information, a terminal device determines, from all the resource offsets in the first terminal device group, a resource offset corresponding to the terminal device. When the network device sends the first configuration information in the unicast manner, the first configuration information may include only a resource offset corresponding to one terminal device. In other words, the network device separately sends, to each terminal device in the first terminal device group, first configuration information corresponding to the terminal device. The first configuration information may include a resource offset corresponding to the terminal device. Alternatively, the resource offset may not need to be carried in the first configuration information. For example, the resource offset may be carried in second configuration information. In this case, the network device may send the first configuration information in the broadcast or multicast manner, and separately send, to each terminal device in the first terminal device group in the unicast manner, second configuration information corresponding to the terminal device.

Alternatively, the resource offset is related to a specific identifier of the terminal device, and the resource offset is used to determine the resource that carries the uplink data of the terminal device. The resource offset is the same as the resource offset described above. However, the resource offset is not configured by the network device, but is determined by the terminal device based on the specific identifier of the terminal device. Because specific identifiers of the terminal devices are different, and resource offsets of the terminal devices are different, resources used by the terminal devices to perform uplink transmission are also different, so that a resource conflict is avoided. Further, optionally, the specific identifier of the terminal device is a cell-radio network temporary identifier (C-RNTI). Based on the method, the network device may not need to send the resource offset to the terminal device, to reduce resource overheads.

Optionally, generation of the DCI is related to the group identifier of the first terminal device group, and the DCI includes scheduling information for uplink transmission and a parity bit corresponding to the DCI. Specifically, the scheduling information for uplink transmission may also be further understood as the foregoing information indicating the second resource, that is, the scheduling information for uplink transmission may be a UL grant. The parity bit corresponding to the DCI is mainly used to detect whether the DCI is interfered and an error occurs in a transmission process. A group identifier of the first terminal device group may be used to scramble the parity bit corresponding to the DCI. After receiving the DCI, the terminal device in the first terminal device group may read the DCI based on the group identifier of the first terminal device group. Even if a device other than the first terminal device group receives the DCI, the device cannot read the DCI because the device does not obtain the group identifier of the first terminal device group. Therefore, based on the method, a case in which a device other than the first terminal device group reads the DCI may be avoided.

Because the resource set is shared by the first terminal device group, after receiving the SR signal, the network device can only determine that there is a terminal device in the first terminal device group needing to transmit data, but cannot determine specific terminal devices that need to transmit data. Therefore, after receiving the uplink data, it is difficult for the network device to distinguish a specific terminal device from which the uplink data comes. To enable the network device to distinguish a specific terminal device from which the received uplink data comes, at least one of the following three methods may be used.

Method 1: The first configuration information further includes a pilot scrambling code identifier, and a pilot port or a pilot sequence of the uplink data of the terminal device is related to the pilot scrambling code identifier. Each terminal device in the first terminal device group has a different pilot scrambling code identifier. The pilot scrambling code identifier is used to scramble a pilot signal of the uplink data. For example, when sending the uplink data, the terminal device scrambles the pilot signal based on the pilot scrambling code identifier, and when receiving the uplink data, the network device blindly detects the pilot signal of the uplink data. Because different terminal devices in the first terminal device group have different pilot scrambling code identifiers, when the network device parses a corresponding pilot signal based on a pilot scrambling code identifier of a terminal device in the first terminal device group, the network device may determine that uplink data corresponding to the pilot signal comes from the terminal device. Optionally, the pilot signal may be a demodulation reference signal (DMRS). Based on the method, different terminal devices in the first terminal device group have different pilot scrambling code identifiers, so that the network device can determine, by blindly detecting the pilot signal of the uplink data, a terminal device that sends the data.

The pilot scrambling code identifier, and the foregoing group identifier of the first terminal device group and the foregoing resource indication information may be sent simultaneously, or may be sent at different time. When the network device sends the first configuration information in the broadcast or multicast manner, the first configuration information includes pilot scrambling code identifiers corresponding to all the terminal devices in the first terminal device group. After receiving the first configuration information, a terminal device determines, from all the pilot scrambling code identifiers in the first terminal device group, a pilot scrambling code identifier corresponding to the terminal device. When the network device sends the first configuration information in the unicast manner, the first configuration information may include only a pilot scrambling code identifier corresponding to one terminal device. In other words, the network device separately sends, to each terminal device in the first terminal device group, first configuration information corresponding to the terminal device. The first configuration information includes a pilot scrambling code identifier corresponding to the terminal device. Alternatively, the pilot scrambling code identifier may not need to be carried in the first configuration information. For example, the pilot scrambling code identifier may be carried in second configuration information. In this case, the network device may send the first configuration information in the broadcast or multicast manner, and separately send, to each terminal device in the first terminal device group in the unicast manner, second configuration information corresponding to the terminal device.

Optionally, a quantity of terminal devices included in the first terminal device group is less than a preset threshold. Limiting the quantity of terminal devices in the first terminal device group helps reduce burden of blind detection performed by the network device.

Method2: A scrambling sequence of the uplink data of the terminal device is related to a specific identifier of the terminal device. Each terminal device in the first terminal device group has a different specific identifier, and the specific identifier of the terminal device is used to scramble uplink data of the terminal device. For example, when sending the uplink data, the terminal device scrambles the uplink data based on the specific identifier of the terminal device, and when receiving the uplink data, the network device blindly detects the uplink data. Because different terminal devices in the first terminal device group have different specific identifiers, when the network device parses corresponding uplink data based on a specific identifier of a terminal device in the first terminal device group, the network device may determine that the uplink data comes from the terminal device. Optionally, the specific identifier of the terminal device may be a C-RNTI. Based on the method, different terminal devices in the first terminal device group have different specific identifiers, so that the network device can determine, by blindly detecting the uplink data, a terminal device that sends the data.

Optionally, a quantity of terminal devices included in the first terminal device group is less than a preset threshold. Limiting the quantity of terminal devices in the first terminal device group helps reduce burden of blind detection performed by the network device.

Method3: The network device may further configure a logical channel identifier (LCID) of the uplink data of the terminal device. Optionally, the first configuration information further includes the LCID. Each terminal device in the first terminal device group has a different LCID. After receiving the uplink data from the terminal device, the network device may read the LCID to determine a specific terminal device from which the uplink data comes. Based on the method, the network device can determine, by using the LCID, the terminal device that sends the data.

In a possible implementation, before step 201 is performed, the method further includes: The network device groups the plurality of terminal devices based on sensing information, where a grouping result includes the first terminal device group, and the sensing information is used to position the terminal device and/or used to determine channel state information of the terminal device. The sensing information is obtained by the network device by sending a sensing signal to the terminal device. Specifically, the network device sends the sensing signal to the terminal device, and receives an echo signal from the terminal device. For example, the echo signal may be reflected by the terminal device, or actively transmitted by the terminal device, or may be transmitted via relay of a third-party device. The echo signal is used to determine the sensing information. The network device may group, by using the sensing information, terminal devices with close locations or beams into one group, so that the terminal devices with close locations or beams can share a same resource set. This helps implement the method described in this embodiment of this application. For example, terminals in a same beam range may be grouped into one group, to ensure that the group of terminal devices have a same large-scale channel characteristic. In addition, the network device may further estimate, with assistance of the sensing information, power strength of the SR signal sent by one terminal device, to estimate, based on power strength of the received SR signal, a quantity of terminal devices that send the SR signal, and infer a quantity of terminal devices that subsequently send the uplink data. This helps reduce a delay of detecting a channel corresponding to the uplink data.

To implement functions in the method provided in this embodiment of this application, the terminal device and the network device each may include a hardware structure and/or a software module, and implement the foregoing functions in a form of the hardware structure, or the software module, or a combination of the hardware structure and the software module. Whether a function in the foregoing functions is performed by using the hardware structure, the software module, or the combination of the hardware structure and the software module depends on particular applications and design constraints of technical solutions.

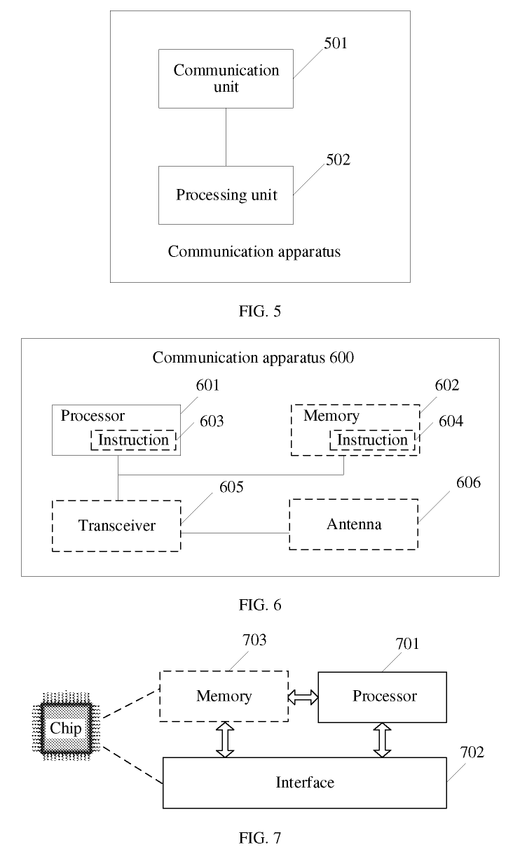

FIG. 5 is a diagram of a structure of a communication apparatus according to an embodiment of this application. The communication apparatus may be a terminal device or a network device. In a possible implementation, the communication apparatus may include modules or units that are in one-to-one correspondence with the methods/operations/steps/actions performed by the terminal device or the network device in the foregoing method embodiment. The unit may be a hardware circuit or software, or may be implemented by the hardware circuit in combination with the software.

The communication apparatus shown in FIG. 5 may include a communication unit 501 and a processing unit 502. The processing unit 502 is configured to process data. A receiving unit and a sending unit are integrated into the communication unit 501. The communication unit 501 may also be referred to as a transceiver unit. Alternatively, the communication unit 501 may be split into a receiving unit and a sending unit.

The communication apparatus shown in FIG. 5 may be a terminal device, or an apparatus that can be used together with the terminal device. The communication apparatus may alternatively be a chip system. The apparatus may be configured to perform a part or all of functions of the terminal device in the method embodiment described in FIG. 2.

The communication unit 501 is configured to send first configuration information, where the first configuration information includes a group identifier of a first terminal device group and resource indication information, and the resource indication information indicates a resource set allocated to the first terminal device group for transmission of a scheduling request signal; and the communication unit 501 is further configured to receive, on a part or all of the resource set, a scheduling request signal sent by one or more terminal devices in the first terminal device group.

In a possible implementation, the first configuration information further includes a response window parameter; and after the communication unit 501 receives, on the part or all of the resource set, the scheduling request signal sent by the one or more terminal devices in the first terminal device group, the communication unit 501 is further configured to: send, on a first resource, downlink control information DCI corresponding to the first terminal device group, where the DCI is used to schedule the one or more terminal devices to perform uplink transmission, and the first resource is determined based on the response window parameter and the part or all of the resource set that carries the scheduling request signal; and receive uplink data from the one or more terminal devices.

In a possible implementation, the first configuration information further includes a resource offset, and the resource offset is used to determine a resource that carries the uplink data of the terminal device.

In a possible implementation, generation of the DCI is related to the group identifier of the first terminal device group, and the DCI includes scheduling information for uplink transmission and a parity bit corresponding to the DCI.

In a possible implementation, the first configuration information further includes a pilot scrambling code identifier, and a pilot port or a pilot sequence of the uplink data of the terminal device is related to the pilot scrambling code identifier.

In a possible implementation, a scrambling sequence of the uplink data of the terminal device is related to a specific identifier of the terminal device.

In a possible implementation, before the communication unit 501 sends the first configuration information, the processing unit 502 is further configured to group a plurality of terminal devices based on sensing information, where a grouping result includes the first terminal device group, and the sensing information is used to position the terminal device and/or used to determine channel state information of the terminal device.

The communication apparatus shown in FIG. 5 may be a network device, or an apparatus that can be used together with the network device. The communication apparatus may alternatively be a chip system. The apparatus may be configured to perform a part or all of functions of the network device in the method embodiment described in FIG. 2.

The communication unit 501 is configured to receive first configuration information from the network device, where the first configuration information includes a group identifier of a first terminal device group and resource indication information, and the resource indication information indicates a resource set allocated to the first terminal device group for transmission of a scheduling request signal; and the communication unit 501 is further configured to send a scheduling request signal to the network device on a part or all of the resource set.

In a possible implementation, the first configuration information further includes a response window parameter; and after the communication unit 501 sends the scheduling request signal to the network device on the part or all of the resource set, the communication unit 501 is further configured to: receive downlink control information DCI from the network device on a first resource, where the DCI is used to schedule a terminal device to perform uplink transmission, and the first resource is determined based on the response window parameter and the part or all of the resource set that carries the scheduling request signal; and send uplink data to the network device.

In a possible implementation, the first configuration information further includes a resource offset, and the resource offset is used to determine a resource that carries the uplink data.

In a possible implementation, generation of the DCI is related to the group identifier of the first terminal device group, and the DCI includes scheduling information for uplink transmission and a corresponding parity bit.

In a possible implementation, the first configuration information further includes a pilot scrambling code identifier, and a pilot port or a pilot sequence of the uplink data is related to the pilot scrambling code identifier.

In a possible implementation, a scrambling sequence of the uplink data is related to a specific identifier of the terminal device.

In a possible implementation, the communication unit 501 is further configured to send an echo signal to the network device, where the echo signal is used to determine sensing information, and the sensing information is used to position the terminal device and/or used to determine channel state information of the terminal device.

FIG. 6 is a diagram of a structure of a communication apparatus. The communication apparatus 600 may be the terminal device in the foregoing method embodiment, or may be a chip, a chip system, a processor, or the like that supports the terminal device in implementing the foregoing method. The communication apparatus may be configured to implement the method described in the foregoing method embodiment. For details, refer to the descriptions in the foregoing method embodiment.

Alternatively, the communication apparatus 600 may be the network device in the foregoing method embodiment, or may be a chip, a chip system, a processor, or the like that supports the network device in implementing the foregoing method. The communication apparatus may be configured to implement the method described in the foregoing method embodiment. For details, refer to the descriptions in the foregoing method embodiment.

The communication apparatus 600 may include one or more processors 601. The processor 601 may be a general-purpose processor, a dedicated processor, or the like. For example, the processor 601 may be a baseband processor or a central processing unit. The baseband processor may be configured to process a communication protocol and communication data. The central processing unit may be configured to: control a communication apparatus (for example, a base station, a baseband chip, a terminal, a terminal chip, a DU, or a CU), execute a software program, and process data of the software program.

Optionally, the communication apparatus 600 may include one or more memories 602. The memory may store instructions 604, and the instructions may be run on the processor 601, so that the communication apparatus 600 performs the method described in the foregoing method embodiment. Optionally, the memory 602 may further store data. The processor 601 and the memory 602 may be separately disposed, or may be integrated together.

Optionally, the communication apparatus 600 may further include a transceiver 605 and an antenna 606. The transceiver 605 may be referred to as a transceiver unit, a transceiver machine, a transceiver circuit, or the like, and is configured to implement a transceiver function. The transceiver 605 may include a receiver and a transmitter. The receiver may be referred to as a receiver machine, a receiver circuit, or the like, and is configured to implement a receiving function. The transmitter may be referred to as a transmitter machine, a transmitter circuit, or the like, and is configured to implement a sending function.

When the communication apparatus 600 is the terminal device, the processor 601 is configured to perform a data processing operation of the terminal device in the foregoing method embodiment; and the transceiver 605 is configured to perform data sending and receiving operations of the terminal device in the foregoing method embodiment.

Alternatively, when the communication apparatus 600 is the network device, the processor 601 is configured to perform a data processing operation of the network device in the foregoing method embodiment; and the transceiver 605 is configured to perform data sending and receiving operations of the network device in the foregoing method embodiment.

In another possible design, the processor 601 may include a transceiver configured to implement receiving and sending functions. For example, the transceiver may be a transceiver circuit, an interface, or an interface circuit. The transceiver circuit, the interface, or the interface circuit configured to implement the receiving and sending functions may be separated, or may be integrated together. The transceiver circuit, the interface, or the interface circuit may be configured to read and write code/data. Alternatively, the transceiver circuit, the interface, or the interface circuit may be configured to transmit or transfer a signal.

In still another possible design, optionally, the processor 601 may store instructions 603. When the instructions 603 are run on the processor 601, the communication apparatus 600 may be caused to perform the method described in the foregoing method embodiment. The instructions 603 may be fixed in the processor 601. In this case, the processor 601 may be implemented by hardware.

In still another possible design, the communication apparatus 600 may include a circuit. The circuit may implement the sending, receiving, or communication function in the foregoing method embodiment. The processor and the transceiver described in this embodiment of this application may be implemented on an integrated circuit (IC), an analog IC, a radio frequency integrated circuit (RFIC), a mixed-signal IC, an application-specific integrated circuit (ASIC), a printed circuit board (PCB), an electronic device, and the like.

The communication apparatus described in the foregoing embodiment may be the terminal device or the network device. However, a scope of the communication apparatus described in this embodiment of this application is not limited thereto, and a structure of the communication apparatus may not be limited by FIG. 6. The communication apparatus may be an independent device or may be a part of a large device. For example, the communication apparatus may be:
(1) an independent integrated circuit IC, a chip, or a chip system or subsystem;
(2) a set that has one or more ICs, where optionally, the IC set may alternatively include a storage component configured to store data and instructions;
(3) an ASIC, for example, a modem (MSM);
(4) a module that can be embedded in another device;
(5) a receiver, a terminal, an intelligent terminal, a cellular phone, a wireless device, a handheld device, a mobile unit, a vehicle-mounted device, a network device, a cloud device, or an artificial intelligence device; or
(6) others.

For a case in which the communication apparatus may be a chip or a chip system, refer to a diagram of a structure of a chip shown in FIG. 7. The chip shown in FIG. 7 includes a processor 701 and an interface 702. Optionally, the chip may further include a memory 703. There may be one or more processors 701, and there may be a plurality of interfaces 702.

In a design, when the chip is configured to implement functions of the terminal device in embodiments of this application,

the interface 702 is configured to input or output a signal; and

the processor 701 is configured to perform a data processing operation of the terminal device in the foregoing method embodiment.

In another design, when the chip is configured to implement functions of the network device in embodiments of this application,

the interface 702 is configured to input or output a signal; and

the processor 701 is configured to perform a data processing operation of the network device in the foregoing method embodiment.

It may be understood that, in some scenarios, some optional features in embodiments of this application may be independently implemented without depending on another feature, for example, a solution on which the optional features are currently based, to resolve a corresponding technical problem and achieve a corresponding effect. Alternatively, in some scenarios, the optional features may be combined with other features based on requirements. Correspondingly, the communication apparatus provided in embodiments of this application may also correspondingly implement these features or functions. Details are not described herein.

It should be understood that the processor in this embodiment of this application may be an integrated circuit chip, and has a signal processing capability. In an implementation process, steps in the foregoing method embodiments may be implemented by using a hardware integrated logical circuit in the processor or by using instructions in a form of software. The processor may be a general-purpose processor, a digital signal processor (DSP), an ASIC, a field programmable gate array (FPGA) or another programmable logic device, a discrete gate or a transistor logic device, or a discrete hardware component.

It may be understood that the memory in this embodiment of this application may be a volatile memory or a nonvolatile memory, or may include the volatile memory and the nonvolatile memory. The nonvolatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), used as an external cache. By way of example but not limitative description, many forms of RAMs may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DR RAM). It should be noted that the memory of the system and method described in this specification includes but is not limited to these memories and any memory of another proper type.

This application further provides a computer-readable medium, configured to store computer software instructions. When the instructions are executed by a communication apparatus, the function in any one of the foregoing method embodiments is implemented.

This application further provides a computer program product, configured to store computer software instructions. When the instructions are executed by a communication apparatus, the function in any one of the foregoing method embodiments is implemented.

All or a part of the foregoing embodiments may be implemented by using software, hardware, firmware, or any combination thereof. When software is used to implement embodiments, all or a part of embodiments may be implemented in a form of a computer program product. The computer program product includes one or more computer instructions. When the computer instructions are loaded and executed on a computer, the procedure or functions according to embodiments of this application are all or partially generated. The computer may be a general-purpose computer, a dedicated computer, a computer network, or another programmable apparatus. The computer instructions may be stored in a computer-readable storage medium, or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, a digital subscriber line (DSL)) or wireless (for example, infrared, radio, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a high-density digital video disc (DVD)), a semiconductor medium (for example, a solid-state drive (SSD)), or the like.

In the foregoing embodiments, the descriptions of each embodiment have respective focuses. For a part that is not described in detail in an embodiment, refer to related descriptions in other embodiments.

1. A scheduling request method, wherein the method comprises:
sending first configuration information, wherein the first configuration information comprises a group identifier of a first terminal device group and resource indication information, and the resource indication information indicates a resource set allocated to the first terminal device group for transmission of a scheduling request signal; and
receiving, on a part or all of the resource set, a scheduling request signal sent by one or more terminal devices in the first terminal device group.

2. The method according to claim 1, wherein the first configuration information further comprises a response window parameter; and
after the receiving, on the part or all of the resource set, the scheduling request signal sent by the one or more terminal devices in the first terminal device group, the method further comprises:
sending, on a first resource, downlink control information (DCI) corresponding to the first terminal device group, wherein the DCI is used to schedule the one or more terminal devices to perform uplink transmission, and the first resource is determined based on the response window parameter and the part or all of the resource set that carries the scheduling request signal; and
receiving uplink data from the one or more terminal devices.

3. The method according to claim 2, wherein the first configuration information further comprises a resource offset, and the resource offset is used to determine a resource that carries the uplink data of the terminal device.

4. The method according to claim 2, wherein generation of the DCI is related to the group identifier of the first terminal device group, and the DCI comprises scheduling information for uplink transmission and a parity bit corresponding to the DCI.

5. The method according to claim 2, wherein the first configuration information further comprises a pilot scrambling code identifier, and a pilot port or a pilot sequence of the uplink data of the terminal device is related to the pilot scrambling code identifier.

6. The method according to claim 2, wherein a scrambling sequence of the uplink data of the terminal device is related to a specific identifier of the terminal device.

7. The method according to claim 1, wherein before the sending the first configuration information, the method further comprises:
grouping a plurality of terminal devices based on sensing information, wherein a grouping result comprises the first terminal device group, and the sensing information is used to position the terminal device and/or used to determine channel state information of the terminal device.

8. A scheduling request method, wherein the method comprises:
receiving first configuration information from a network device, wherein the first configuration information comprises a group identifier of a first terminal device group and resource indication information, and the resource indication information indicates a resource set allocated to the first terminal device group for transmission of a scheduling request signal; and
sending a scheduling request signal to the network device on a part or all of the resource set.

9. The method according to claim 8, wherein the first configuration information further comprises a response window parameter; and
after the sending the scheduling request signal to the network device on the part or all of the resource set, the method further comprises:
receiving downlink control information (DCI) from the network device on a first resource, wherein the DCI is used to schedule a terminal device to perform uplink transmission, and the first resource is determined based on the response window parameter and the part or all of the resource set that carries the scheduling request signal; and
sending uplink data to the network device.

10. The method according to claim 9, wherein the first configuration information further comprises a resource offset, and the resource offset is used to determine a resource that carries the uplink data.

11. The method according to claim 9, wherein generation of the DCI is related to the group identifier of the first terminal device group, and the DCI comprises scheduling information for uplink transmission and a corresponding parity bit.

12. The method according to claim 9, wherein the first configuration information further comprises a pilot scrambling code identifier, and a pilot port or a pilot sequence of the uplink data is related to the pilot scrambling code identifier; or a scrambling sequence of the uplink data is related to a specific identifier of the terminal device.

13. The method according to claim 8, wherein the method further comprises:
sending an echo signal to the network device, wherein the echo signal is used to determine sensing information, and the sensing information is used to position the terminal device and/or used to determine channel state information of the terminal device.

14. A communication apparatus, comprising a processor, the processor is configured to, when executing the programming instructions, enable the communication apparatus to:
send first configuration information, wherein the first configuration information comprises a group identifier of a first terminal device group and resource indication information, and the resource indication information indicates a resource set allocated to the first terminal device group for transmission of a scheduling request signal; and
receive, on a part or all of the resource set, a scheduling request signal sent by one or more terminal devices in the first terminal device group.

15. The apparatus according to claim 14, wherein the first configuration information further comprises a response window parameter; and
after the receive, on the part or all of the resource set, the scheduling request signal sent by the one or more terminal devices in the first terminal device group, the processor further enable the communication apparatus to:
send, on a first resource, downlink control information (DCI) corresponding to the first terminal device group, wherein the DCI is used to schedule the one or more terminal devices to perform uplink transmission, and the first resource is determined based on the response window parameter and the part or all of the resource set that carries the scheduling request signal; and
receive uplink data from the one or more terminal devices.

16. The apparatus according to claim 15, wherein the first configuration information further comprises a resource offset, and the resource offset is used to determine a resource that carries the uplink data of the terminal device.

17. The apparatus according to claim 15, wherein generation of the DCI is related to the group identifier of the first terminal device group, and the DCI comprises scheduling information for uplink transmission and a parity bit corresponding to the DCI.

18. The apparatus according to claim 15, wherein the first configuration information further comprises a pilot scrambling code identifier, and a pilot port or a pilot sequence of the uplink data of the terminal device is related to the pilot scrambling code identifier.

19. The apparatus according to claim 15, wherein a scrambling sequence of the uplink data of the terminal device is related to a specific identifier of the terminal device.

20. The apparatus according to claim 14, wherein before the send the first configuration information, the processor further enable the communication apparatus to:
group a plurality of terminal devices based on sensing information, wherein a grouping result comprises the first terminal device group, and the sensing information is used to position the terminal device and/or used to determine channel state information of the terminal device.
